(19) United States
(12) Patent Application Publication
(10) Pub. No.: US 2021/0364866 A1
(43) Pub. Date: Nov. 25, 2021

(54) PIXEL ELECTRODE STRUCTURE AND DISPLAY DEVICE

(71) Applicant: SHENZHEN CHINA STAR OPTOELECTRONICS SEMICONDUCTOR DISPLAY TECHNOLOGY CO., LTD., Shenzhen (CN)

(72) Inventor: Wu CAO, Shenzhen (CN)

(73) Assignee: SHENZHEN CHINA STAR OPTOELECTRONICS SEMICONDUCTOR DISPLAY TECHNOLOGY CO., LTD., Shenzhen (CN)

(21) Appl. No.: 16/616,987

(22) PCT Filed: Oct. 30, 2019
(86) PCT No.: PCT/CN2019/114179

§ 371 Date: Nov. 26, 2019

(30) Foreign Application Priority Data
Sep. 4, 2019 (CN) 201910830381.9

(51) Int. Cl. G02F 1/1343

(52) U.S. Cl. CPC G02F 1/134309

(57) ABSTRACT

A pixel electrode structure and a display device are provided. The pixel electrode structure includes a boundary stem region and a branch region; wherein the boundary stem region includes a stem electrode; the branch region includes a plurality of branch electrodes, and the branch electrodes are arranged in parallel with each other and connected to the stem electrode; a gap is formed between two adjacent branch electrodes; at least one branch electrode includes a first electrode section and a second electrode section, the second electrode section is connected between the first electrode section and the stem electrode; and a width of the first electrode section is less than a width of the second electrode section.

### FIELD OF INVENTION

The present invention relates to the field of display technologies, and in particular, to a pixel electrode structure and a display device.

### BACKGROUND OF INVENTION

Orientation of liquid crystal molecules is significantly related to liquid crystal efficiency, which is specifically expressed as an inclination angle and a rotational azimuth angle (specifically related to the positive and negative polarities of the liquid crystal molecules). Liquid crystal efficiency refers to the ability of transmit and rotate the direction of incident light so that the light can emit from a polarizer in an emitting direction.

Distribution of a pixel electrode structure is an important design item. In FIG. 1, label L refers to a width of a branch electrode 102′ of a pattern region of a pixel electrode, and label S refers to a width of a gap 100′ between the two adjacent branch electrodes 102′, the sum of both widths S and L is P. Generally, the smaller the P value is, the better the display effect of the display panel is. The common P value has reached 5 μm or even lower.

In conventional art, the sum P of both widths S and L is the same, and a proportional relationship between the L and the S is very subtle. Theoretically, the larger L is, the given vertical electric field is strong, the inclination angle is improved, and the liquid crystal efficiency is higher. However, from simulation results, due to boundary between the branch electrode 102′ and a stem electrode 101′ is affected by a complex electric field, the smaller the L is, the higher the liquid crystal efficiency is, but there is a peak design.

In a whole pixel, a ratio of the width L of the branch electrode 102′ to the width S of the gap 100′ between the branch electrodes 102′ or the sum P of both S and L, remains unchanged, that is, it does not change with different regions. In the liquid crystal efficiency analysis, when an upper and a lower polarizers of a pixel unit are rotated by 45° (the liquid crystal portion which is not ideally deflected is reflected), it is found that orientation states of the liquid crystals at the stem electrodes 101′ in a boundary stem region and at both sides of a data line 2, or at the stem electrode 101′ in a boundary region of the pixel are inconsistent; wherein the liquid crystal molecules at the stem electrode 101′ of a cross stem region are completely collapsed and rotated in a horizontal and vertical direction, and molecular states of the liquid crystal at the stem electrode in the boundary stem region are complicated, except that the azimuth angle of the plane is not disordered, its inclination degree is poor, and the latter accounts for the majority, resulting in a significant decrease in efficiency/transmittance.

### Technical Problem

In order to solve the above technical problems, the present invention provides a pixel electrode structure and a display device, which changes a partial width L of a branch electrode or a width of a gap S between the branch electrodes, the branch electrode is changed in a proportional relationship between L and S to improve liquid crystal efficiency and transmittance.

### SUMMARY OF INVENTION

### Technical Solution

A technical solution to solve the above problems is as follows. The present invention provides a pixel electrode structure including a boundary stem region and a branch region; wherein the boundary stem region includes a stem electrode; the branch region includes a plurality of branch electrodes, and the branch electrodes are arranged in parallel with each other and connected to the stem electrode; a gap is formed between two adjacent branch electrodes; the at least one branch electrode includes a first electrode section and a second electrode section, the second electrode section is connected between the first electrode section and the stem electrode; and a width of the first electrode section is less than a width of the second electrode section.

In an embodiment of the invention, a central axis of the first electrode section and a central axis of the second electrode section are staggered and parallel to each other in the same branch electrode.

In an embodiment of the invention, a central axis of the first electrode section coincides with a central axis of the second electrode section in the same branch electrode.

In an embodiment of the invention, a width of a second electrode section of one of the branch electrodes is same as a width of a second electrode section of the other branch electrode in any two different branch electrodes.

In an embodiment of the invention, a width of a second electrode section of one of the branch electrodes is different from a width of a second electrode section of the other branch electrode in any two different branch electrodes.

In an embodiment of the invention, a width of one of the gaps is same as or different from a width of the other gap in any two different gaps.

In an embodiment of the invention, the branch electrode and the stem electrode include an included angle between 30° and 60°.

In an embodiment of the invention, the branch electrode further includes a third electrode section connected between the first electrode section and the second electrode section, the first electrode section has a rectangular cross-section, the second electrode section has a rectangular cross-section, and the third electrode section has a trapezoidal cross-section with a wide upper portion and a narrow lower portion.

In an embodiment of the invention, a difference between a width of the second electrode section and a width of the first electrode section is less than or equal to 2 μm.

The present invention further provides a display device including a pixel electrode structure according to above mentioned pixel electrode structure.

### Beneficial Effect

The pixel electrode structure and the display device of the present invention can effectively improve the serious deterioration of the liquid crystal inclination angle and the problems caused thereof such as low actual efficiency or low transmittance of those regions by increasing the width of the branch electrode at the boundary region of the pixel, so as to improve the inclination efficiency and effectively improve the liquid crystal transmittance.

### BRIEF DESCRIPTION OF FIGURES

In order to illustrate the technical solutions of the present disclosure or the related art in a clearer manner, the drawings desired for the present disclosure or the related art will be described hereinafter briefly. Obviously, the following drawings merely relate to some embodiments of the present disclosure, and based on these drawings, a person skilled in the art may obtain the other drawings without any creative effort.

The following description of each embodiment, with reference to the accompanying drawings, is used to exemplify specific embodiments which may be carried out in the present invention.

FIG. 1 is a structural view showing a branch electrode and a stem electrode of a pixel electrode structure in the conventional art.

FIG. 2 is a structural view showing a pixel electrode according to a first embodiment of the present invention.

FIG. 3 is a structural view showing a branch electrode and a stem electrode according to the first embodiment of the present invention, mainly showing the structure of the branch electrode.

FIG. 4 is a structural view showing the branch electrode and the stem electrode according to the first embodiment of the present invention, mainly showing a distribution structure of branch electrodes with varying widths.

FIG. 5 is a structural view showing the branch electrode and the stem electrode according to a second embodiment of the present invention, mainly showing a central axis of a first electrode section and a central axis of a second electrode section are staggered and parallel to each other in the same branch electrode.

FIG. 6 is a structural view showing the branch electrode and the stem electrode according to a third embodiment of the present invention, in which one of the two different branch electrodes has a width different from that of the other second electrode.

FIG. 7 is a structural view showing the branch electrode and the stem electrode according to a fourth embodiment of the present invention, mainly showing the structure of the branch electrode.

The reference numerals are as follows:
1, pixel electrode structure; 2, data line; 3, common electrode;
11, main region; 12, sub-region; 13, transistor distribution region;
14, boundary stem region; 15, cross stem region; 16, branch region;
101′ and 101, stem electrode; 102′ and 102, branch electrode; 100′ and 100, gap;
1021, first electrode section; 1022, second electrode section; 1023, third electrode section;
1001, a central axis of the first electrode section; 1002, a central axis of the second electrode section; and
10, display device.

### DETAILED DESCRIPTION OF EMBODIMENTS

The embodiments of the present invention are described in detail below, and the examples of the embodiments are illustrated in the drawings, wherein the same or similar reference numerals indicate the same or similar elements or elements having the same or similar functions. The embodiments described below with reference to the drawings are intended to be illustrative of the invention and are not to be construed as limiting.

The following description of the embodiments is intended to be illustrative of the specific embodiments. The directional terms mentioned in the present invention, such as “upper”, “lower”, “front”, “back”, “left”, “right”, “top”, and “bottom”, etc., are only referred to the direction of the additional schema. Therefore, the directional terminology used is for the purpose of illustration and understanding of the invention.

### First Embodiment

In order to clarify the design points of the present invention more clearly, a pixel electrode structure 1 of the present invention will be described by taking an eight-domain pixel structure as an example.

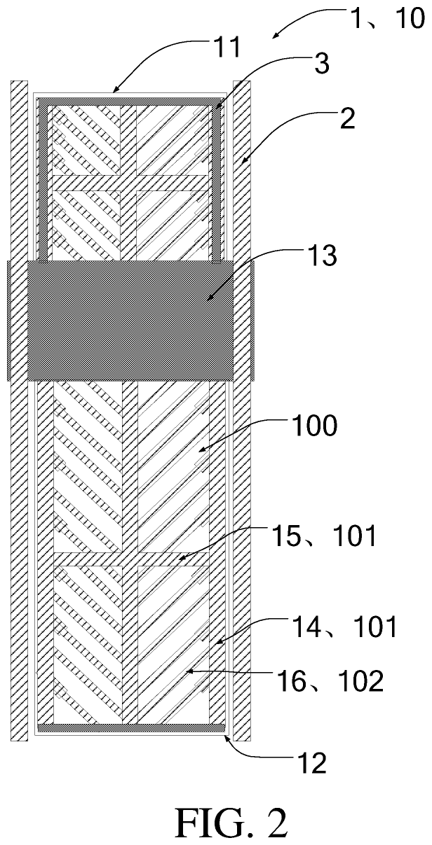

As shown in FIG. 2, the pixel electrode structure 1 of the present invention includes a main region 11 and a sub-region 12, and a transistor distribution region 13 connected between the main region 11 and the sub-region 12. Data lines 2 are distributed on both sides of the main region 11 and the sub-region 12. A common electrode 3 is also distributed on the main region 11 and the sub-region 12.

The main region 11 and the sub-region 12 each have a pixel electrode, and the pixel electrode includes a boundary stem region 14, a cross stem region 15, and a branch region 16. The boundary stem region 14 surrounds the cross stem region 15, and the branch region 16 is formed between the boundary stem region 14 and the cross stem region 15.

The boundary stem region 14 and the cross stem region 15 each has a stem electrode 101. The branch region 16 has a plurality of branch electrodes 102 therein. The branch electrodes 102 are arranged in parallel with each other and connected to the stem electrode 101. The branch electrode 102 and the stem electrode 101 have an included angle between 30° and 60°, it is preferably 45°.

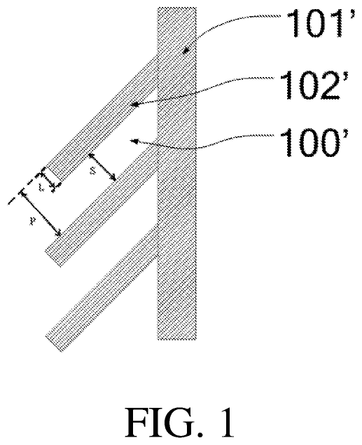

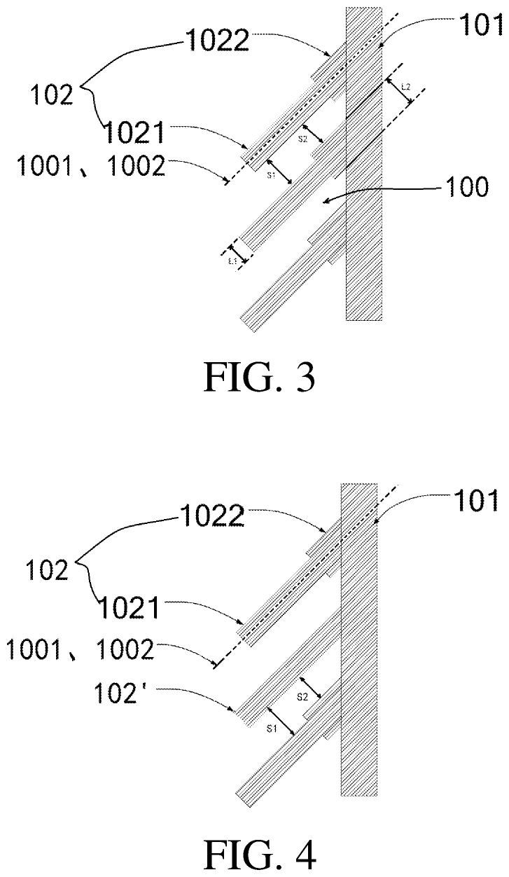

As shown in FIG. 3, in the present embodiment, there is a gap 100 between adjacent two branch electrodes 102, wherein at least one branch electrode 102 has a first electrode section 1021 and a second electrode section 1022, and the second electrode section 1022 is connected between the first electrode section 1021 and the stem electrode 101. A width of the first electrode section 1021 is less than a width of the second electrode section 1022, wherein the width of the first electrode section 1021 is labeled L1 in FIG. 3, the width of the second electrode section 1022 is labeled L2 in FIG. 3, that is, L1 is less than L2. A width of the gap 100 between the second electrode section 1022 and a branch electrode 102 adjacent thereto is labeled S1. A width of the gap 100 between the second electrode section 1022 and the adjacent branch electrode 102 is labeled S2. In a structure of the conventional branch electrode 102′, the width of the gap 100′ between the adjacent two branch electrodes 102′ is generally equal, that is, the width of the gap 100′ is labeled S as shown in FIG. 1. However, in the present embodiment, by changing the width of the second electrode section 1022, the width of the first electrode section 1021 is less than the width of the second electrode section 1022, that is, L1 is less than L2. In this way, the width of the gap 100 between the second electrode 1022 and the adjacent branch electrode 102 is changed, so that the edge points on the branch electrode 102 with the width changed are different from the distance to the adjacent branch electrode 102, effectively improving the liquid crystal efficiency and transmittance. For example, the width S1 of a portion of the gap 100 is greater than the width S2 of another portion of the gap 100.

In the present embodiment, as shown in FIG. 3, in the same branch electrode 102, a central axis 1001 of the first electrode section coincides with a central axis 1002 of the second electrode section.

In this embodiment, the difference between a width L2 of the second electrode section 1022 and a width L1 of the first electrode section 1021 is less than or equal to 2 μm. The width of the second electrode section 1022 is not excessively large, and is generally controlled within 2 μm, preferably ranges from 1 to 1.5 μm. Furthermore, the gap 100 between the adjacent two branch electrodes 102 need to satisfy the requirement of actual production process, it is required that the gap 100 between adjacent two branch electrodes 102 therefore be of sufficient width, typically greater than 1 μm and less than 3 μm. In the actual fabrication process, a junction between the branch electrode 102 and the stem electrode 101 eventually becomes a relatively smooth boundary due to the passivation effect of an actual etching process, and thus is advantageous for the orientation of the liquid crystal.

Referring to FIG. 2, in the branch region 16, the width of all the branch electrodes 102 can be changed to form a structure having a first electrode and a second electrode.

In the present embodiment, in any two different branch electrodes 102, the width of the second electrode section 1022 of one of the branch electrodes is same as the width of the second electrode section of the other branch electrode. In any two different gaps 100, a width of one of the gaps 100 is same as or different from a width of the other gap 100.

Because in a pixel boundary region, especially at both sides of the data line 2 or the gate trace, the liquid crystal molecules are affected by the dissipative electric field and the like, and the inclination state is not as good as a central region of the pixel electrode, that is, the liquid crystal inclination angles are seriously deteriorated, resulting lower actual efficiency or transmittance in those region. Therefore, in order to improve the problem that the liquid crystal efficiency in the pixel boundary region is too low, the width of the branch electrode 102 is increased, and a voltage difference and an electric field are formed with an upper plate to improve the inclination effect. In other words, the objective is achieved by designing to increase the width of the branch electrode 102 at the pixel boundary region.

When the width L2 of the branch electrode 102 connected to the stem electrode 101 at the boundary is increased, the width of the gap 100 between the branch electrodes 102 is changed, that is, the changes of widths S1 and S2. The symmetry axes of the second electrode section 1022 and the first electrode section 1021 can be coincided or staggered, and the widened branch electrodes 102 can be implemented for each branch electrode or a specific number of branch electrodes.

As shown in FIG. 4, of course it is also possible to select a part of the branch electrodes 102 to form the first electrode section and the second electrode section. When the electrodes are arranged, the branch electrodes 102 of which the width is changed and the branch electrodes 102′ of the unaltered width disposed at intervals. In the present embodiment, in the main region 11, the branch electrodes 102 connected to the stem electrode 101 are all provided with the first electrode section and the second electrode section, and in the sub-region 12, the branch electrodes 102 connected to the stem electrode 101, wherein the branch electrodes 102 of which the width is changed and the branch electrodes 102′ of the unaltered width are disposed at intervals.

### Second Embodiment

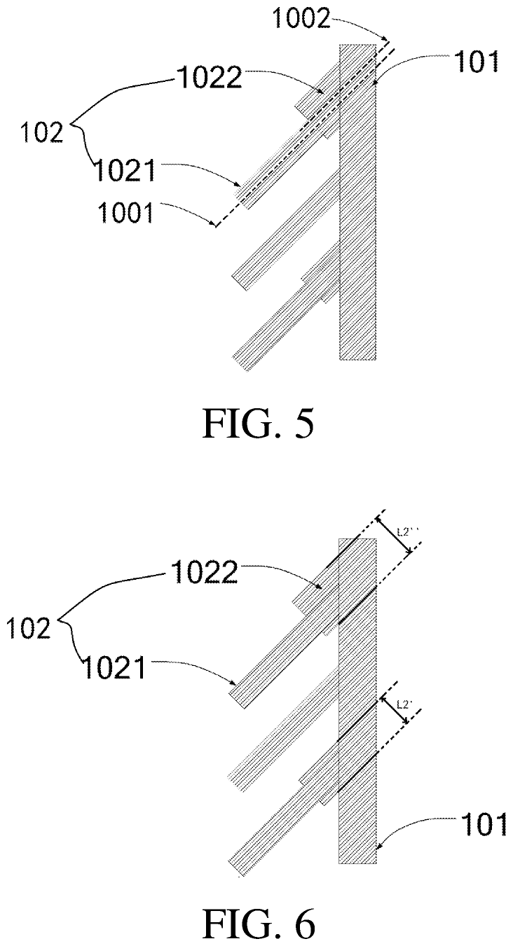

As shown in FIG. 5, in order to further improve the liquid crystal efficiency and the transmittance, the second embodiment differs from the first embodiment in that the central axis 1001 of the first electrode section 1021 and the central axis 1002 of the second electrode section 1022 are staggered and parallel to each other in the same branch electrode 102. In a specific implementation, in a width direction of the second electrode section 1022, the widths of both sides of the second electrode section are increased differently, so that the central axis 1002 of the second electrode section can be shifted from the central axis 1001 of the first electrode section 1021.

### Third Embodiment

As shown in FIG. 6, this third embodiment differs from the first or the second embodiment in that, in any two different branch electrodes 102 of the third embodiment, a width of a second electrode section 1022 of one of the branch electrodes is different from a width of a second electrode section of the other branch electrode. That is, one of the second electrode sections 1022 has a width L2′, the other second electrode section 1022 has a width L2″, and the width L2′ is not equal to the width L2″. In this way, it is easier to make a difference in the distance between the edge points on one branch electrode 102 and the adjacent one of the branch electrodes 102, which effectively improves the liquid crystal efficiency and the transmittance.

### Fourth Embodiment

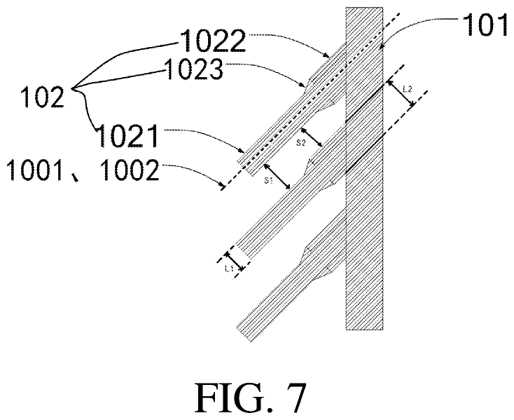

As shown in FIG. 7, the fourth embodiment differs from the first to third embodiments in that the branch electrode 102 of the fourth embodiment further includes a third electrode section 1023, and the third electrode section 1023 is connected between the first electrode section 1021 and the second electrode section 1022, wherein the first electrode section 1021 has a rectangular cross-section, the second electrode section 1022 has a rectangular cross-section, and the third electrode section 1023 has a trapezoidal cross-section with a wide upper portion and a narrow lower portion. The third electrode section 1023 has an upper end and a lower end, an area of the upper end is less than an area of the lower end, and the upper end of the third electrode section 1023 is connected to the first electrode section 1021 and the lower end of the third electrode section 1023 is connected to the second electrode section 1022.

The present invention further provides a display device 10, referring to FIG. 3, including the pixel electrode structure 1 of any of first to fourth embodiments. Since the main design point of the present invention lies in the pixel electrode structure 1, other devices or structures in the display device, such as a light-emitting layer, etc., will not be described again.

Embodiments of the present invention have been described, but not intended to impose any unduly constraint to the appended claims. For a person skilled in the art, any modification of equivalent structure or equivalent process made according to the disclosure and drawings of the present invention, or any application thereof, directly or indirectly, to other related fields of technique, is considered encompassed in the scope of protection defined by the claims of the present invention.

What is claimed is:

1. A pixel electrode structure, comprising a boundary stem region and a branch region; wherein the boundary stem region comprises a stem electrode;
the branch region comprises a plurality of branch electrodes, and the branch electrodes are arranged in parallel with each other and connected to the stem electrode; a gap is formed between two adjacent branch electrodes;
the at least one branch electrode comprises a first electrode section and a second electrode section, the second electrode section is connected between the first electrode section and the stem electrode; and
a width of the first electrode section is less than a width of the second electrode section.

2. The pixel electrode structure according to claim 1, wherein a central axis of the first electrode section and a central axis of the second electrode section are staggered and parallel to each other in the same branch electrode.

3. The pixel electrode structure according to claim 1, wherein a central axis of the first electrode section coincides with a central axis of the second electrode section in the same branch electrode.

4. The pixel electrode structure according to claim 1, wherein a width of a second electrode section of one of the branch electrodes is same as a width of a second electrode section of the other branch electrode in any two different branch electrodes.

5. The pixel electrode structure according to claim 1, wherein a width of a second electrode section of one of the branch electrodes is different from a width of a second electrode section of the other branch electrode in any two different branch electrodes.

6. The pixel electrode structure according to claim 1, wherein a width of one of the gaps is same as or different from a width of the other gap in any two different gaps.

7. The pixel electrode structure according to claim 1, wherein the branch electrode and the stem electrode comprise an included angle between 30° and 60°.

8. The pixel electrode structure of claim 1, wherein the branch electrode further comprises a third electrode section connected between the first electrode section and the second electrode section, the first electrode section has a rectangular cross-section, the second electrode section has a rectangular cross-section, and the third electrode section has a trapezoidal cross-section with a wide upper portion and a narrow lower portion.

9. The pixel electrode structure according to claim 1, wherein a difference between a width of the second electrode section and a width of the first electrode section is less than or equal to 2 μm.

10. A display device comprising a pixel electrode structure according to claim 1.
